(19) United States
(12) Patent Application Publication
(10) Pub. No.: US 2023/0270107 A1
(43) Pub. Date: Aug. 31, 2023

(54) No Rinse Disinfectant with Virucidal Properties Against Non-Enveloped Viruses

(71) Applicant: LONZA, LLC, Morristown, NJ (US)

(72) Inventors: Xiao Jiang, Morristown, NJ (US); Marcus Bentley, Morristown, NJ (US); Craig Carter, Morristown, NJ (US)

(21) Appl. No.: 18/041,221

(22) PCT Filed: Aug. 17, 2021
(86) PCT No.: PCT/US2021/046228

§ 371 Date: Feb. 10, 2023

Related U.S. Application Data
(60) Provisional application No. 63/066,909, filed on Aug. 18, 2020.

(51) Int. Cl. A01N 33/12; A01P 1/00

(52) U.S. Cl. CPC A01N 33/12; A01P 1/00

(57) ABSTRACT

A disinfectant composition and method of use are disclosed that is particularly effective against viruses such as the Coronavirus and Norovirus. The disinfectant composition contains a carbonate/bicarbonate salt of a quaternary ammonium compound or didecyl dimethyl ammonium chloride and water. The quaternary ammonium compound is at very low concentrations while still remaining effective against viruses and hospital bacteria. The disinfectant composition can contain an anti-microbial agent at concentrations that meets the environmental protection agencies level for food tolerance. Thus, the composition can be sprayed onto an adjacent surface without having to undergo a potable water rinse.

### CROSS REFERENCE TO RELATED APPLICATION

This application claims filing benefit of U.S. Provisional Patent Application Ser. No. 63/066,909, having a filing date of Aug. 18, 2020, which are incorporated herein by reference for all purposes.

### BACKGROUND

Pathogenic organisms, such as bacteria, fungi, and viruses, continue to cause infections in humans as well as domestic animals and pets. The Coronavirus pandemic, for instance, has not only overloaded the medical system and caused countless deaths but has also disrupted commerce and has led to increased unemployment. Disinfectant formulations have been developed over the last several decades to reduce or destroy pathogenic organisms and accordingly, reduce the rate of infection. Literally any hard surface including floors, walls, countertops, windows, windowsills, sinks, faucets, waste containers, appliances, and cabinet surfaces can become contaminated. Disinfectants have been developed to treat hard surfaces for use in hospitals, rest homes, schools, and homes.

Many different types of anti-microbial agents have been suggested in the past in formulating disinfectants. For instance, such anti-microbial agents have included alcohols, chlorine compounds, glutaraldehyde, hydrogen peroxide, iodophors, peracetic acid, phenolics, and quaternary ammonium compounds. In order to facilitate application, increase the range of activity against different types of microorganisms or otherwise increase efficacy, the above anti-microbial agents have been used at high concentrations and in combination with many other agents, ingredients and components. Such disinfectant compositions are formulated to have a relatively high or relatively low pH in order to increase effectiveness. Consequently, many disinfectant compositions are not well suited to contacting the user's hands or skin or may be corrosive to the surfaces to which they are applied.

Formulations that increase efficacy by increasing the concentration of the anti-microbial agents can also have limited approved applications. For example, 40 CFR § 180.940 provides tolerance exemptions for active and inert ingredients for use in antimicrobial formulations (Food-contact surface sanitizing solutions). When certain anti-microbial agents are present in disinfectant compositions at concentrations above those permitted under the above regulation; the disinfectant composition must be rinsed from the surface to which it was applied and/or not be used to disinfect the surface.

Further, problems still persist in formulating a disinfectant that is effective against all different types of microorganisms, such as various viruses. Viruses are divided into families on the basis of size, symmetry, type of nucleic acid genome or deoxyribonucleic acid and mode of replication. Viruses of different families, for instance, vary in their resistance to disinfectants. For instance, enveloped viruses are usually more sensitive to disinfectants and thus can be more easily controlled than non-enveloped viruses. Non-enveloped viruses have a complex outer structure and are more resistant to not only disinfectants, but also harsh environmental conditions. One example of a non-enveloped virus is the Norovirus. The Norovirus can cause viral gastroenteritis in humans. The Norovirus can affect people of all ages. Outbreaks of the Norovirus infection can occur, for instance, in closed or semi-closed communities, such as long-term care facilities, overnight camps, hospitals, schools, prisons, clubs, dormitories, and cruise ships, where the infection can spread very rapidly.

In view of the above, a need currently exists for a disinfectant composition that is effective against viruses such as non-enveloped viruses and disinfectant-resistant bacteria. A need particularly exists for a disinfectant composition capable of destroying viruses, such as the Norovirus and the Coronavirus, that has a relatively low amount of anti-microbial agent, does not contain any harsh chemicals, and has a relatively neutral pH. In addition, a need exists for a disinfectant composition having the above qualities and that is within the tolerance exemptions of 40 CFR § 180.940.

### SUMMARY

In general, the present disclosure is directed to a disinfectant composition and to a method of using the composition to destroy microorganisms, such as viruses and bacteria. The composition and method of the present disclosure is particularly well suited to not only destroying the Coronavirus on contact but also capable of destroying non-enveloped viruses, such as the Norovirus. Of particular advantage, the disinfectant composition of the present disclosure can be formulated to contain a single type of anti-microbial agent, can primarily contain water, and can be free of commonly used adjuvants, such as surfactants, chelating agents, stabilizers, pH adjusters, and the like. Due to the manner in which the disinfectant composition is formulated, the disinfectant composition can have a relatively neutral pH and can be applied to surfaces without having to be rinsed off later while still being very effective against hard to kill viruses and bacteria.

In one aspect, the present disclosure is directed to a method for destroying viruses and/or bacteria on an adjacent surface. The method includes applying a disinfectant composition to a surface contaminated with a virus or a hospital bacteria. The disinfectant composition contains only a single type of anti-microbial agent. The anti-microbial agent is generally a quaternary ammonium compound. More particularly, the anti-microbial agent is a dimethyl dialkyl ammonium compound, such as dimethyl didecyl ammonium chloride. In another aspect, the anti-microbial agent comprises a carbonate or a bicarbonate salt of a quaternary ammonium cation combined with water.

The carbonate or bicarbonate salt of the quaternary ammonium cation or the dimethyl didecyl ammonium chloride can be present in the anti-microbial composition at a concentration of greater than about 200 ppm and less than about 500 ppm, such as greater than about 300 ppm and less than about 475 ppm, such as greater than about 310 ppm and less than about 400 ppm. The method can further include the step of allowing the disinfectant composition to air dry on the surface without the need of a potable water rinse.

When the surface is contaminated with the Norovirus, the disinfectant composition can produce a 3-log reduction in the population in the Norovirus after 5 minutes and/or after drying. Similarly, when the surface is contaminated with the Coronavirus, the disinfectant composition can produce a 3-log reduction in the population of the Coronavirus after 5 minutes and/or after drying. The log reduction in the population of the virus can be tested according to the GLP AOAC virucidal test after five minutes of contact time.

Alternatively, the surface can be contaminated with Staphylococcus aureus, Pseudomonas aeruginosa, or Salmonella enterica and wherein the disinfectant composition produces a 1 out of 60 or less result when tested according to AOAC germicidal spray test under GLP conditions.

The carbonate or bicarbonate salt of the quaternary ammonium cation can be a carbonate or bicarbonate salt of a C8 to C20 dialkyl and C1 to C3 dialkyl ammonium quaternary cation. For example, in one particular embodiment, the carbonate or bicarbonate salt of the quaternary ammonium cation is a carbonate or bicarbonate salt of a didecyldimethyl ammonium quaternary cation. The disinfectant composition can be formulated so as to only contain the carbonate and/or bicarbonate salt of the quaternary ammonium cation without containing any other anti-microbial agents. The disinfectant composition can primarily contain water. For instance, water can be present in the composition in an amount greater than about 99% by weight.

In one aspect, the disinfectant composition can comprise a concentrate and the method can further include the step of diluting the concentrate prior to applying to the adjacent surface. The concentrate can be diluted only with water. The dilution ratio of water to concentrate can be from about 64 to 1 to about 500 to 1, such as from about 120 to 1 to about 135 to 1. The disinfectant composition applied to the surface can have a pH of less than 9.5, such as less than 9, such as less than 8.8, such as less than 8.6, such as less than 8.4, such as less than 8.2, such as less than 8 and generally greater than 7, such as greater than about 7.5

In one embodiment, the method can further include the step of spraying the disinfectant composition on to the surface or saturating a liquid absorbent substrate, such as a nonwoven, with the disinfectant composition and wiping the surface for applying the disinfectant composition to the surface.

Other features and aspects of the present disclosure are discussed in greater detail below.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a disinfectant composition and method for destroying problematic microorganisms, such as bacteria and viruses. The disinfectant composition of the present disclosure can be formulated so as to contain extremely low amounts of only a single type of anti-microbial agent while still remaining very effective against even the hardest to kill microorganisms. In fact, the disinfectant composition can be formulated with antimicrobial concentrations that meet food tolerance levels as promulgated by the US Environmental Protect Agency. Thus, in some embodiments, the disinfectant composition can be applied to the surface and need not be later rinsed with potable water. Even containing low concentrations of the anti-microbial agent, the disinfectant composition of the present disclosure is still very effective against all different types of viruses, including enveloped viruses and non-enveloped viruses.

Many disinfectant compositions, for instance, are ineffective against non-enveloped viruses that have a complex outer structure and are more resistant to harsh environmental conditions. These viruses can be particularly dangerous. For instance, the Norovirus, which is a non-enveloped virus, can cause viral gastroenteritis in humans and can quickly multiply when not controlled leading to outbreaks in closed or semi-closed communities, such as long-term care facilities, overnight camps, hospitals, schools, prisons, clubs, dormitories, cruise ships, and the like.

Of particular advantage, the disinfectant composition of the present disclosure is efficacious against all different types of viruses, including the Norovirus and the Coronavirus, while containing only a single type of anti-microbial agent at relatively low concentrations. The anti-microbial agent contained within the disinfectant composition is a quaternary ammonium compound, such as a carbonate and/or bicarbonate salt of a quaternary ammonium compound or a dimethyl didecyl ammonium chloride, or mixtures thereof. Quaternary ammonium compounds have been widely used as disinfectants for wipe applications. Quaternary ammonium compounds, however, are typically formulated with many other ingredients including other anti-microbial agents in order to achieve efficacy against many hard to kill microorganisms, such as non-enveloped viruses. In hard surface disinfecting applications, however, there is a growing demand for ingredient transparency to the consumer in both the household and professional cleaning markets. In fact, government regulations are now requiring ingredient transparency. Consequently, there is a consumer demand to develop disinfectant compositions with less ingredients that can still rapidly inactivate microorganisms, such as the Norovirus, on hard surfaces. The disinfectant composition of the present disclosure is directed to the use of a particular type of a quaternary ammonium compound that has been found to provide quick disinfecting performance against viruses and hospital bacteria at very low concentrations without the need for other ingredients, such as other anti-microbial agents, surfactants, chelating agents, stabilizers, and the like. In fact, carbonate and/or bicarbonate salts of quaternary ammonium compounds have been found to naturally possess effective chelating properties.

In one aspect, the disinfectant composition of the present disclosure only contains a carbonate and/or bicarbonate salt of a quaternary ammonium cation or dimethyl didecyl ammonium chloride in combination with water. The water can comprise any suitable potable water. Of particular advantage, the disinfectant composition can have a relatively neutral pH which is significantly different than many disinfectant compositions used in the past that require relatively high pH levels. For example, the pH of the disinfectant composition of the present disclosure can be less than 9, such as less than about 8.8, such as less than about 8.6, such as less than about 8.4, such as less than about 8.2, such as less than about 8, such as less than about 7.8, such as less than about 7.6. The pH is generally greater than about 6.9, such as greater than about 7. In one aspect, the pH of the composition is between about 7.5 and 9 including all increments of 0.1 therebetween. Through the use of the particular ammonium quat described above and by having a neutral pH, the disinfectant composition is extremely mild to the skin. In addition, the composition is also very mild to the surface to which it is applied. For example, the composition is not corrosive to metals, plastics, or other materials.

As described above, the disinfectant composition of the present disclosure generally contains only a single type of anti-microbial agent. More particularly, the disinfectant composition only contains a carbonate and/or bicarbonate salt of a quaternary ammonium cation or only contains dimethyl didecyl ammonium chloride. In one aspect, the disinfectant composition only contains a carbonate and/or a bicarbonate salt of a quaternary ammonium cation as the anti-microbial agent and contains no other anti-microbial agents. For instance, the disinfectant composition can be free of other quaternary ammonium compounds, can be free of tertiary amine anti-microbial agents, and can be free of preservatives. In one aspect, the disinfectant composition is free of guanidine compounds, such as biguanide or polybiguanide compounds.

Quaternary ammonium carbonate and/or a bicarbonate compounds of the present disclosure include a quaternary ammonium cation that contains a nitrogen atom connected to four alkyl groups or aryl-substituted alkyl groups. In one aspect, the nitrogen atom is connected to two C8 to C20 alkyl groups and two C1 to C3 alkyl groups, such as methyl groups. In one embodiment, a quaternary ammonium carbonate can be represented by the following formula:

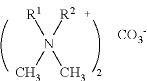

wherein R¹ is a C₁-C₂₀ alkyl or aryl-substituted alkyl group and R² is a C₈-C₂₀ alkyl group, and preferably wherein R¹ is the same as R² and R¹ is a C₈-C₁₂ alkyl group, as well as compositions further comprising the corresponding quaternary ammonium bicarbonate

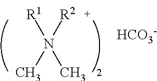

wherein R¹ is the same or a different C₁-C₂₀ alkyl or aryl-substituted alkyl group as above and R² is the same or a different C₈-C₂₀ alkyl group as above, but preferably wherein R¹ is the same as R² and R¹ is a C₈-C₁₂ alkyl group.

In one embodiment, the first anti-microbial agent contained in the composition comprises a di C₈-C₁₂ alkyl ammonium carbonate/bicarbonate. For example, in one particular embodiment, the anti-microbial or preservative composition contains didecyl dimethyl ammonium carbonate and didecyl dimethyl ammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

In addition to carbonate/bicarbonate salts of quaternary ammonium cations, the anti-microbial agent can also be a dimethyl dialkyl ammonium compound. Dimethyl dialkyl ammonium compounds include dimethyl dioctyl ammonium compounds such as dimethyl dioctyl ammonium chloride, dimethyl didecyl ammonium compounds such as dimethyl didecyl ammonium chloride and the like.

The single type of anti-microbial agent, such as a carbonate and/or bicarbonate salt of the quaternary ammonium cation or a dimethyl didecyl ammonium chloride, can be contained in the disinfectant composition at very low amounts and still have effectiveness against a broad range of microorganisms including viruses and hospital bacteria. The viruses can include non-enveloped viruses such as the Norovirus and can include the Coronavirus. As used herein, a “hospital bacterium” refers to any bacterium from the genus of Staphylococcus, Pseudomonas, or Salmonella. Examples of hospital bacterium include Staphylococcus aureus, Pseudomonas aeruginosa, or Salmonella enterica. In one aspect, for instance, the carbonate and/or bicarbonate salt of the quaternary ammonium cation or dimethyl didecyl ammonium chloride can be present in the disinfectant composition at a concentration of less than about 500 ppm, such as less than about 475 ppm, such as less than about 450 ppm, such as less than about 425 ppm. In one aspect, the carbonate and/or bicarbonate salt of the quaternary ammonium cation or dimethyl didecyl ammonium chloride is present in the disinfectant composition at a concentration of less than 400 ppm which then qualifies the disinfectant composition as meeting the Environmental Protection Agency's food tolerance level. More particularly, in one embodiment, the disinfectant composition can be formulated to be within the tolerance exemptions of 40 CFR § 180.940. For example, the carbonate and/or bicarbonate salt of the quaternary ammonium cation or dimethyl didecyl ammonium chloride can be present in the disinfectant composition in an amount less than about 390 ppm, such as in an amount less than about 380 ppm, such as in an amount less than about 370 ppm, such as in an amount less than about 360 ppm, such as in an amount less than about 350 ppm. The carbonate and/or bicarbonate salt of the quaternary ammonium cation or dimethyl didecyl ammonium chloride is generally present in the disinfectant composition in an amount greater than about 200 ppm, such as in an amount greater than about 300 ppm, such as in an amount greater than about 310 ppm.

In one aspect, the remainder of the disinfectant composition is water. The water can be any suitable potable water and can be distilled water, tap water, or a combination thereof. In one aspect, for instance, the disinfectant composition as applied to an adjacent surface, contains water in an amount greater than 99% by weight. For instance, water can be present in the disinfectant composition in an amount greater than about 99.4% by weight, such as in an amount greater than about 99.6% by weight, such as in an amount greater than about 99.8% by weight, such as in an amount greater than about 99.9% by weight. At the above water amount levels, the disinfectant composition has very mild characteristics when contacted with the human skin and can have a much more neutral pH than many disinfectant compositions proposed in the past, especially disinfectant compositions designed to destroy viruses, such as the Coronavirus, and hospital bacteria.

In one aspect, water is the only solvent contained within the disinfectant composition of the present disclosure. Optionally, minor amounts of other organic solvents may be added depending upon the particular application. Such organic solvents can be present in an amount less than 0.1% by weight, such as in an amount less than about 0.05% by weight.

The organic solvent, for instance, may comprise an alcohol. Suitable alcohols include, for instance, ethanol, propanol, benzyl alcohol, phenoxyethanol, isopropanol, and mixtures thereof. Alternatively, the organic solvent may comprise a glycol ether. Examples of glycol ethers include diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol n-butyl ether, ethylene glycol dimethyl ether, ethylene glycol diethyl ether, ethylene glycol dibutyl ether, propylene glycol n-butyl ether, propylene glycol n-propyl ether, tripropylene glycol methyl ether, dipropylene glycol methyl ether, dipropylene glycol butyl ether, dipropylene glycol n-propyl ether, ethylene glycol hexyl ether and combinations thereof. In one embodiment, for instance, the organic solvent present in the composition comprises dipropylene glycol n-propyl ether, ethylene glycol phenyl ether, or mixtures thereof.

Of particular advantage, the disinfectant composition of the present disclosure can be free of many of the other additives and components that are typically incorporated into these types of products. Consequently, the disinfectant composition of the present disclosure can have a vary small list of ingredients that complies with current consumer demands. For example, the disinfectant composition of the present disclosure can be free of any pH builders, pH buffers, pH adjusters, basic compounds, or the like. As described above, the disinfectant composition of the present disclosure is very effective at relatively neutral pH's, even at pH levels less than 8.5.

The disinfectant composition of the present disclosure can also be free of surfactants. For example, the disinfectant composition of the present disclosure can be free on anionic surfactants, can be free of cationic surfactants, can be free of nonionic surfactants, can be free of amphoteric surfactants, and can be free of zwitterionic surfactants.

The disinfectant composition of the present disclosure can also be free of a chelating agent. In fact, the carbonate and/or bicarbonate salt of the quaternary ammonium cation has some chelating properties that makes the use of a chelating agent optional, even when combined with relatively hard water.

The disinfectant composition of the present disclosure can also be free of corrosion inhibitors. For instance, not only does the disinfectant composition have a relatively neutral pH but the carbonate and/or bicarbonate salt of the quaternary ammonium cation is not corrosive to metals or many other materials.

The disinfectant composition of the present disclosure can also be free of complexing agents, preservatives, fragrances, colorance, and the like.

In one embodiment, the disinfectant composition of the present disclosure can be formulated and shipped to customers as a concentrate and then diluted at the point of use. Of particular advantage, it was discovered that diluting the disinfectant composition, even with substantial amounts of tap water or hard water, does not degrade the effectiveness of the anti-microbial properties. Thus, end users can simply dilute the product with tap water to the desired dilution ratio and apply to surfaces. For instance, the disinfectant composition can be sold as a concentrate and then diluted only with water such that the dilution ratio of water to concentrate is from about 10:1 to about 500:1. For example, the dilution ratio to obtain the desired concentration of the anti-microbial agent can be, in one embodiment, from about 64:1 to about 128:1 based on the ratio of water to concentrate. In one aspect, the dilution ratio of water to concentrate can be from about 120:1 to about 135:1. The dilution ratio can be based on volume.

Various different microorganisms may be killed or controlled in accordance with the present disclosure. For instance, the disinfectant composition of the present disclosure can control gram positive bacteria, gram negative bacteria, and the like. In addition to bacteria, the disinfectant composition of the present disclosure can also kill and control the growth of various other microorganisms, such as fungi, spores, yeast, mycobacteria, and the like. Of particular advantage, the disinfectant composition of the present disclosure is particularly well suited for destroying viruses, such as the Coronavirus and even non-enveloped viruses such as the Norovirus.

For example, the disinfectant composition of the present disclosure, when applied to an adjacent surface, can produce a three-log reduction in the population of any Norovirus present after drying. As used herein, the reduction in the population of a virus on a surface treated is measured according to the AOAC virucidal effectiveness test under GLP conditions (and thus is not tested on the actual surface being treated). The AOAC test is based on ASTM Test E1053. The test contact time is five minutes. Disinfectant compositions made according to the present disclosure can demonstrate a four-log reduction in the population of the Norovirus and even a five-log reduction in the population of Norovirus.

The disinfectant composition of the present disclosure also has the same or better efficacy against the Coronavirus. For example, the Environmental Protection Agency and the Centers for Disease Control and Prevention recognize that certain microorganisms can be ranked with respect to their tolerance to chemical disinfectants. With this approach, viruses are divided into three viral subgroups which includes small non-enveloped viruses, large non-enveloped viruses, and enveloped viruses based on their relative resistance to disinfectants. According to this hierarchy, if a disinfectant composition can kill a small, non-enveloped virus such as the Norovirus, the disinfectant composition is also able to kill any large, non-enveloped virus or any enveloped virus. The Coronavirus, for instance, is an enveloped virus. Thus, the disinfectant composition of the present disclosure can display at least a three-log reduction in the population of the Coronavirus, such as at least a four-log reduction in the population of a Coronavirus, such as at least a five-log reduction in population of a Coronavirus after a 5 minute contact time.

In addition to viruses, the disinfectant composition of the present disclosure is particularly effective against hospital bacterium. For example, the disinfectant formulation is effective at destroying the Staphylococcus aureus, Pseudomonas aeruginosa, or Salmonella enterica. In order to determine the effectiveness of the disinfectant composition against a bacterium, such as a hospital grade bacteria, the composition can be tested according to the AOAC germicidal spray test under GLP conditions (and thus is rated under laboratory conditions and not on the surface itself being disinfected). When tested according to the AOAC germicidal spray test, the disinfectant composition can pass the test by showing one or less growth out of 60 tubes tested and over three batches of the disinfectant composition. The test contact time is five minutes.

The disinfectant composition of the present disclosure can be applied to a surface using any suitable technique. In one aspect, for instance, the disinfectant composition can be sprayed onto the surface to be disinfected. As described above, the disinfectant composition contains the anti-microbial agent in such low concentrations that the disinfectant composition is in compliance with the Environmental Protection Agency's food tolerance level and therefore need not be rinsed off the surface once applied and can be allowed to air dry.

Surfaces, which may be disinfected with the compositions include, but are not limited to, those located in dairies, homes, health care facilities, canneries, food processing plants, restaurants, hospitals, institutions, and industry. Any suitable hard surface may be treated in accordance with the present disclosure, particularly frequently touched hard surfaces. The hard surface, for instance, can be made from glass, a metal such as an aluminum or stainless steel, a ceramic, a stone such as granite or marble, a plastic or polymer material, or the like. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. Areas in hospitals would include beds, gurneys, tables, canisters, toilets, waste cans, stands, cabinets, shower stalls, floors, doorknobs, bed rails, walls or any other non-porous surface.

In addition to spraying the composition onto an adjacent surface, the disinfectant composition can also be applied to a surface using a wiping product. In one embodiment, the disinfectant composition can be impregnated into wipes that are stored in a container and dispensed one at a time. The container with the wipes may contain a single wipe, or several wipes. Suitable containers include a pouch containing a single wipe, such as a moist towelette which is torn open by the user, or may be a pouch with a resealable opening containing several wipes in a stacked fashion, a rolled fashion or other suitable formation that would allow a single wipe to be removed from the opening at a time. Pouches are generally prepared form a fluid impervious material, such as a film, a coated paper or foil or other similar fluid impervious materials. In another way to dispense wipes of the present disclosure is to place the wipe into a fluid impervious container having an opening to access the wipes in the container. Containers may be molded plastic container with lids that are fluid impervious. Generally, the lid will have an opening to access the wipes in the container. The wipe in the container may be in an interleaved stack, such that as a wipe is removed from the container, the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Usually, in the rolled form, the wipe material is fed from the center of the rolled material. As with the interleaved stack, as a wipe is removed from the container, the next wipe is positioned in the opening to facilitate removal of the next wipe, when needed.

The disinfectant composition can be impregnated into the wipe such that the wipe is pre-moistened and will express or release the disinfectant composition onto the surface as the wipe is run across the surface to be treated. Generally, the disinfectant composition is saturated into the wipe such that the wipe will release the disinfectant composition to the surface through the wiping action. Generally, the disinfectant composition is used from about 2 parts to 10 parts by weight per 1 part by weight of the wiper substrate, more preferably from about 3 to about 5 parts by weight per 1 part by weight of the wiper substrate. In these ranges, complete saturation of the substrates can be achieved. It is noted that the amount of the wiping solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

The following examples are intended to provide a more complete understanding of the present invention. The examples are not intended, however, to limit the invention.

### Examples

Various different disinfectant compositions were formulated in accordance with the present disclosure and tested against hospital bacterium and a non-enveloped virus.

The disinfectant compositions contained didecyldimethyl ammonium bicarbonate/carbonate or didecyldimethyl ammonium chloride and water. Concentrated formulations were first produced and then diluted. The following disinfectant compositions were formed.

TABLE 1
Formulation Details

| | Sample A | Sample B | Sample C |
|---|---|---|---|
| Ingredient | (1:128) | (1:500) | (1:500) |
| didecyldimethyl | 4.39 | | 7.5 |
| ammonium | | | |
| bicarbonate/ | | | |
| carbonate | | | |
| didecyldimethyl | | 4.36 | |
| ammonium | | | |
| chloride | | | |
| DI Water | 95.61 | 95.64 | 92.5 |
| Dilution Ratio | 1:128 | 1:128 | 1:500 |

Micro-Efficacy Testing

Sample A in Table 1, was sent to a laboratory for evaluation of hospital grade bacteria, using AOAC germicidal spray test (GST) method under GLP conditions. This method is in compliance with the requirements of the U.S. Environmental Protection Agency (EPA). Three batches of the test samples are required for the GLP efficacy test against the hospital grade bacteria. According to the test method and the regulatory agency, performance standard for bactericidal activity is 1 positive carrier out of 60 for S. aureus, P. aeruginosa and S. enterica. The test contact time is 5 minutes. The 1:128 dilution rate of the test is defined as 1 part of test sample and 127 parts 200 ppm un-softened tap water, which results in 343 ppm of active ammonium quaternary compound in the test substance. The micro efficacy test results are shown in Table 2.

TABLE 2
GLP AOAC GST(AOAC 961.02) testing against hospital
grade bacteria at 5 min. contact time

| | Results expressed as number of tubes | | |
|---|---|---|---|
| | exhibiting growth/total Number of Tubes | | |
| Test Organisms | Batch 1 | Batch 2 | Batch 3 |
| S. aureus | 0/60 (Pass) | 0/60 (Pass) | 1/60 (Pass) |
| S. enterica | 0/60 (Pass) | 0/60 (Pass) | 0/60 (Pass) |
| P. aeruginosa | 1/60 (Pass) | 0/60 (Pass) | 1/60 (Pass) |

Sample A and Sample B were sent to a laboratory for evaluation of the virucidal efficacy. Sample A was tested under GLP conditions, while Sample B was not. AOAC virucidal effectiveness test of a disinfectant for use on hard surfaces against Feline Calicivirus as a surrogate virus for human Norovirus, was used for the test. Feline Calicivirus, also a member of the Caliciviridae family, serves as a valuable model virus for efficacy testing of Norovirus, since these viruses share many similar characteristics and Feline Calicivirus can be propagated in cell cultures. The test procedure was to simulate the way in which the product is intended to be used. This method is in compliance with the requirements of the U.S. Environmental Protection Agency (EPA). The test contact time is 5 minutes. The 1:128 dilution rate of the test is defined as 1 part of test sample and 127 parts 200 ppm un-softened tap water, which results in 343 ppm of active ammonium quaternary amine compound in the test substance of Sample A and 341 ppm of active ammonium quaternary amine compound in the test substance of Sample B. The EPA efficacy performance for label claims requires the test sample demonstrating at least a three Log₁₀ reduction in titer beyond the cytotoxic level. The micro efficacy test results are shown in Table 3.

TABLE 3
GLP AOAC virucidal test against Norovirus at 5 min. contact time

| | Sample A Log | | Sample B Log |
|---|---|---|---|
| | Reduction | | Reduction |
| Test Organism | Batch 1 | Batch 2 | Batch 1 |
| Norovirus Surrogate | ≥4.82 (Pass) | ≥5.00 (Pass) | ≥5.00 (Pass) |
| (Feline Calicivirus) | | | |

Sample C in Table 1, was sent to a laboratory for evaluation of food contact sanitization under GLP conditions, using AOAC method Germicidal and Detergent Sanitizing Action of Disinfectants. Two batches of the test samples are required for the GLP food contact sanitization efficacy test. The 1:500 dilution rate of the test is defined as 1 part of test sample and 499 parts 500 ppm AOAC synthetic hard water, which results in 150 ppm of active ammonium quaternary amine compound in the test substance. The micro efficacy test results are shown in Table 4.

TABLE 4
GLP AOAC Food contact sanitization test at 30 sec. contact time

Percent Reduction

| Test Organism | Batch 1 | Batch 2 |
|---|---|---|
| Escherichia | 99.999% (Pass) | >99.999% (Pass) |
| Coli | | |
| Klebsiella | >99.999% (Pass) | >99.999% (Pass) |
| pneumoniae | | |
| Salmonella | >99.999% (Pass) | >99.999% (Pass) |
| typhimurium | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A method for destroying viruses and/or bacteria on an adjacent surface comprising:
applying a disinfectant composition to a surface contaminated with a virus or a hospital bacterium, the disinfectant composition containing only a single type of antimicrobial agent, the antimicrobial agent comprising a carbonate or a bicarbonate salt of a quaternary ammonium cation or a dimethyl dialkyl quaternary ammonium chloride combined with water, the carbonate or bicarbonate salt of the quaternary ammonium cation or the dimethyl dialkyl quaternary ammonium chloride being present in the antimicrobial composition at a concentration of greater than about 200 ppm and less than about 500 ppm.

2. A method as defined in claim 1, further comprising the step of allowing the disinfectant composition to air-dry on the surface without the need of a potable water rinse.

3. A method as defined in claim 1, wherein the carbonate or bicarbonate salt of the quaternary ammonium cation or the dimethyl dialkyl quaternary ammonium chloride is present in the antimicrobial composition at a concentration of greater than about 300 ppm and less than about 475 ppm.

4. A method as defined in claim 1, wherein the carbonate or bicarbonate salt of the quaternary ammonium cation or the dimethyl dialkyl quaternary ammonium chloride is present in the antimicrobial composition at a concentration of greater than about 310 ppm and less than about 400 ppm.

5. A method as defined in claim 1, wherein the disinfectant composition produces a 3-log reduction in a population of the Norovirus after drying.

6. A method as defined in claim 1, wherein the disinfectant composition produces a 3-log reduction in the population of a Coronavirus after drying.

7. A method as defined in claim 1, wherein the surface is contaminated with Staphylococcus aureus, Pseudomonas aeruginosa, or Salmonella enterica and wherein the disinfectant composition, when tested according to the AOAC germicidal spray test under GLP conditions, passes the test by showing one or less growth out of 60 samples tested.

8. A method as defined in claim 1, wherein the antimicrobial agent is the carbonate or bicarbonate salt of the quaternary ammonium cation and is a carbonate or bicarbonate salt of a C8 to C20 dialkyl and C1 to C3 dialkyl ammonium quaternary cation.

9. A method as defined in claim 8, wherein the carbonate or bicarbonate salt of the quaternary ammonium cation is a carbonate or bicarbonate salt of a didecyldimethyl ammonium quaternary cation. A method as defined in claim 1, wherein the disinfectant composition contains water in an amount greater than 99% by weight.

10. A method as defined in claim 1, wherein the disinfectant composition comprises a concentrate and wherein the method further includes the step of diluting the concentrate prior to applying to the surface.

11. A method as defined in claim 9, wherein the concentrate is diluted only with water, the dilution ratio of water to concentrate being from about 64 to 1 to about 500 to 1.

12. A method as defined in claim 9, wherein the concentrate is diluted only with water, the dilution ratio of water to concentrate being from about 120 to 1 to about 135 to 1.

13. A method as defined in claim 1, wherein the disinfectant composition has a pH of about 7 to about 9.

14. A method as defined in claim 1, wherein the disinfectant composition does not contain a chelating agent.

15. A method as defined in claim 1, wherein the disinfectant composition does not contain a surfactant.

16. A method as defined in claim 1, wherein the disinfectant composition does not contain a pH adjuster or basic compound.

17. A method as defined in claim 1, wherein the disinfectant composition does not contain a preservative.

18. A method as defined in claim 1, wherein the disinfectant composition only contains water and the carbonate or bicarbonate salt of the quaternary ammonium cation.

19. A method as defined in claim 1, wherein the method further includes the step of saturating a liquid absorbent substrate with the disinfectant composition and wiping the surface for applying the disinfectant composition to the surface.

20. A method as defined in claim 1, wherein applying the disinfectant composition to the surface includes the step of spraying the disinfectant composition onto the surface.

21. A method as defined in claim 1, wherein the disinfectant composition is within the tolerance exemptions of 40 CFR § 180.940.

22. A method as defined in claim 1, wherein the antimicrobial agent is didecyl dimethyl ammonium chloride.
